(19) United States
(12) Patent Application Publication
(10) Pub. No.: US 2014/0313102 A1
(43) Pub. Date: Oct. 23, 2014

(54) MULTI-SCREEN POWER MANAGEMENT

(71) Applicant: Martin Hennelly, Berkshire (GB)

(72) Inventor: Martin Hennelly, Berkshire (GB)

(73) Assignee: NEC CORPORATION, Tokyo (JP)

(21) Appl. No.: 14/357,149

(22) PCT Filed: Aug. 23, 2012
(86) PCT No.: PCT/JP2012/071929

§ 371 Date: May 8, 2014

(30) Foreign Application Priority Data
Nov. 15, 2011 (GB) 1119709.2

(51) Int. Cl. G06F 1/32; G06F 3/14

(52) U.S. Cl. CPC G06F 1/3265; G06F 3/1423
USPC 345/1.3

(57) ABSTRACT

The invention provides for an electronic device having a first surface area offering a first display and a second surface area offering a second display, the device being arranged to display different images on the first and second displays and having independent power management functionality for the first and second displays and operative while the displays are displaying the said different images, and to a method of active power management control for respective multiple screens within such a device.

### TECHNICAL FIELD

The present invention relates to power management within a multi-screen electronic device and in particular to an electronic device offering such power management and to a power management method for use in such a device.

### BACKGROUND ART

Increasingly, electronic devices such media players, telecommunication and computer devices in general seek to enhance usability by the provision of multi-, and generally two, screens. Such devices are generally by their nature portable and so rely on on-board battery power supplies for functionality. Also such devices increasingly employ two or more screens offering equivalent performance such as when measured by characteristics of screen resolution, colour rendering and touch-input capability.

Performance aspects such as power requirement, and related characteristics of lifetime before re-charge and overall battery size and weight, become important considerations for mobile devices in particular, but also for mains powered devices given the on-going need for ever improved energy efficiency. However, where each of the two or more screens is to have the potential to offer equivalent high performance, power savings through separate and differing screen design configurations are not available.

A wide variety of, generally dual screen devices, are known from, for example, CN 201153274; CN 101276234; KR 0080065507; KR 20030034358 and WO 9821709.

However, in each device, both screens, when actually subject to power management are managed as if a single entity and so from a power management perspective the device actually functions as a single screen device.

Where, in these known devices, some feature of seemingly separate power management is provided, this is simply limited to the possibility of powering-up/down each screen separately and, for example, offering a basic on/off function depending on the physical condition of the device. As noted for some of these known devices. this may embody itself in a foldable phone having inner/outer screens which alternate respectively between on/off states depending upon the open/closed state of the phone.

Of course, it should be appreciated that, in no way do such known devices encompass aspects of ongoing power management as the screens continue to display its required image(s).

The power management within such known multi-screen devices is therefore disadvantageously limited and this in turn limits the scope for reducing power consumption having knock-on disadvantages relating to battery/device size/weight and operational lifetime.

### SUMMARY

The present invention seeks to provide for a multi-screen electronic device, and related method of operation and software functionality having advantages over known devices, methods and functionality.

According to a first aspect of the present invention there is provided an electronic device having a first surface area offering first display and a second surface area offering a second display, the device being arranged to display different images on the first and second displays and having independent power management functionality for the first and second displays and operative while the displays are displaying the said different images.

Such independent power management functionality provides a ready means for determining that each of the displays operates with power use functionality dependent upon the nature of the displayed image and which can be quite different for each display.

As one feature of the invention, the device can be arranged such that applications running on the device are arranged to control the power management functionality. In particular, the applications are arranged to access a power management system of the device.

In one arrangement, the device is arranged to control the power management functionality in relation to power-dependent display characteristics of each of the displayed images. Examples of such power-dependent display characteristics can comprise brightness, contrast and period between sleep mode during which the required image is not displayed.

Advantageously, access for the said applications to the power management functionality can be achieved by way of an Application Program Interface (API). In this manner, the said interface is arranged to be exposed to an application running on the device.

In one particular embodiment, the applications can be arranged to be created within a Software Development Kit (SDK) having the relevant Application Program Interfaces exposed.

According to a further feature of the present invention, the device includes user interface means allowing for the programming of threshold levels of power dependent display characteristics within the power management functionality. In particular, the user-interface can allow for variation of the said threshold levels in an application-dependent manner. The power management functionality can then advantageously operate within ranges set by the user and which can differ dependent upon the particular display-requirements of an application.

As will be appreciated, the electronic device comprises a multi-display device. However, the multiple display can be provided on respective multiple screens or, functionally, a single screen can be divided as appropriate to provide for quite discrete displays each having their own respective power management.

Of course, any screen, or screens, providing the displays can include touch functionality serving to represent a user interface for the device.

The present invention is relevant to any form of electronic device offering separate displays whether or not a mobile device and whether or not relying upon an on-board battery power supply, or a connected mains power supply.

The invention is relevant to small computing devices and communications devices and media players represent examples of electronic devices to which the present invention is particularly relevant.

According to another aspect of the present invention there is provided a method of power management for an electronic device having a first surface area offering a first display and a second surface area offering a second display, the device being arranged to display different images on the first and second displays, and the method including the step of providing power management to the first and second displays independently of each other and while both the first and second displays are displaying the said different images.

The advantageous further features of the electronic device discussed above likewise have relevance to the present invention as embodied in such a method as defined immediately above.

Thus, as a feature of this aspect of the invention, the method can include the step of controlling the power management by means of an application running on the device. In particular, the applications can access a power management system of the device.

The step of controlling the power management functionality can be taken responsive to power-dependent display characteristics of each of the displayed images and such as those characteristics discussed above.

Advantageously, the step of accessing the power management functionality can be achieved by way of an Application Program Interface. In this manner, the method can include the step of exposing the interface to an application running on the device.

Yet further, the method can include exposure of the Application Program Interface by way of a Software Development Kit within which the applications have been created.

As noted, the method of the present invention can be employed within any form of electronic device offering separate displays whether or not a mobile device and whether or not relying upon an on-board battery power supply, or a connected mains power supply.

Again, portable computing devices, communications devices and media players represent examples of electronic devices to which the present invention is particularly relevant.

As will therefore be appreciated from the above, a particularly efficient power management arrangement can be embodied within both a method and electronic device. As will be appreciated, and as required, a single application running over multiple screens of a device can provide independently control the power management of each screen. Thus, the multi-screen computing device platform can advantageously support independent power management of each of the multiple screens and, to enhance usability having regard to the potentially wide variety of applications, and associated display requirements, that might be arranged to run on the device, provision can be made for the user to interface with the device to adjust display parameters separately for each screen and separately for each application.

Of course, the control functionality of the present invention can be provided by way of is any appropriate software or hardware configuration. Also, the present invention can relate to a computer program having instructions which, when executed, provide for a method as defined above.

Yet further, the invention can provide for a computer program product comprising such a computer program and, still further, the invention can provide for a computer-readable medium having a computer program product recorded thereon.

### BRIEF DESCRIPTION OF THE DRAWINGS

The invention is described further hereinafter, by way of example only, with reference to the accompanying drawings in which:

FIG. 1 is an illustration of a state machine according to the current art and which is employed for the power management of single, and multi-, screen devices;

FIG. 2 is an illustration of a state machine arising in accordance with one embodiment of the present invention and illustrated in relation to a dual-screen device; and

FIG. 3 is a schematic diagram of a mobile dual-screen electronic device according to an embodiment of the present invention.

### DETAILED DESCRIPTION OF EXEMPLARY EMBODIMENTS

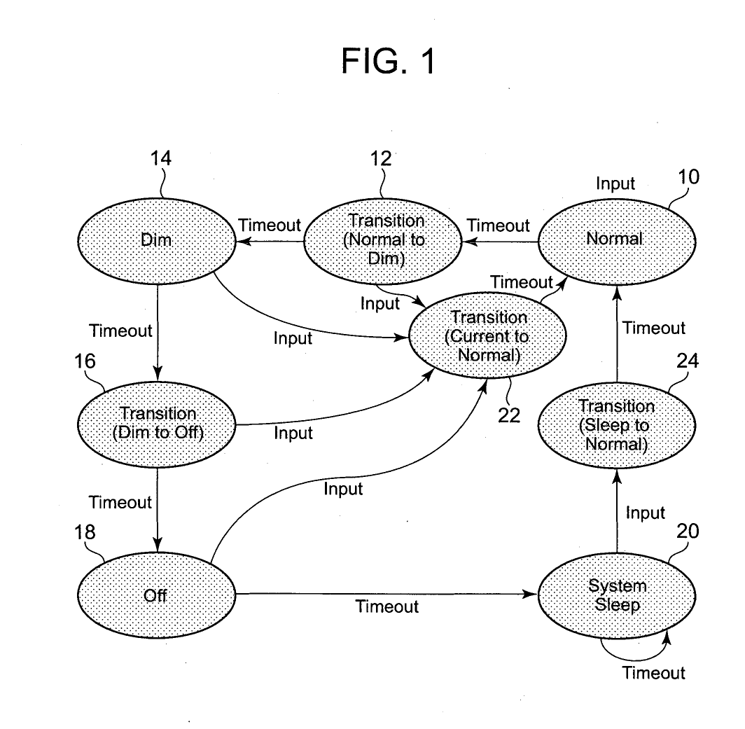

Turning first therefore to FIG. 1, there is provided a state machine diagram illustrating the power management within the current art for the management of a single, or multi-, screen device. As regards the power management functionality within such a known device during display of the required images, the screens of such known multiscreen devices are managed as a single entity.

Considering the normal state 10 of the device, such a state remains while the “input” self-loop transition is ongoing and as a user interface is being accessed by any user. However, once input ceases, a time-out is monitored for a. possible transition, by way of a. “Transition (Normal to Dim)” state 12 during which the Power Management function would change the screen brightness from the Normal brightness to Dim brightness, to a “Dim” state 14 for the display screen of the device. Less power is therefore consumed in running the screen with a “dimmed” display. Should a further time-out to be recognised, the device transitions, by way of a “Transition (Dim to Off)” state 16 in which the screen brightness is reduced from the “Dim” brightness level to the “Off” brightness level, to an “Off” state 18 for the display and so to further limit the power requirement and thus enhance power saving.

Of course, during either of the transition states 12, 16, or either of the steady states 14, 18, resumed user input at the user interface causes a transition to the “Transition (Current to Normal)” state 22 in which the screen brightness is increased from the current level to the “Normal brightness level back to the normal state 10. In any of the steady states 10, 14, an Application Program Interface (API) allows the application to suppress transitions to states 12 and 16 respectively, through overriding the timeout.

However should, while in the “Off” state 18, the user make no further input attempt, the device can transition via a time-out to a “System Sleep” state 20 in which further reductions in power requirement, and further power savings, can be made.

The device can remain in such a “System Sleep” state 20 until such time as user input is detected which provides for a transition to the “Transition (Sleep to Normal) state 24 in which the screen brightness is increased to the Normal brightness level back towards the “Normal” state operation 10 after an appropriate timeout.

As noted, such a state machine is relevant to the power management operation of all known display devices, whether multi-display or not, during the display of the required images and since, for power management purposes during such display, the different screens of a multi-screen device are treated as the single entity.

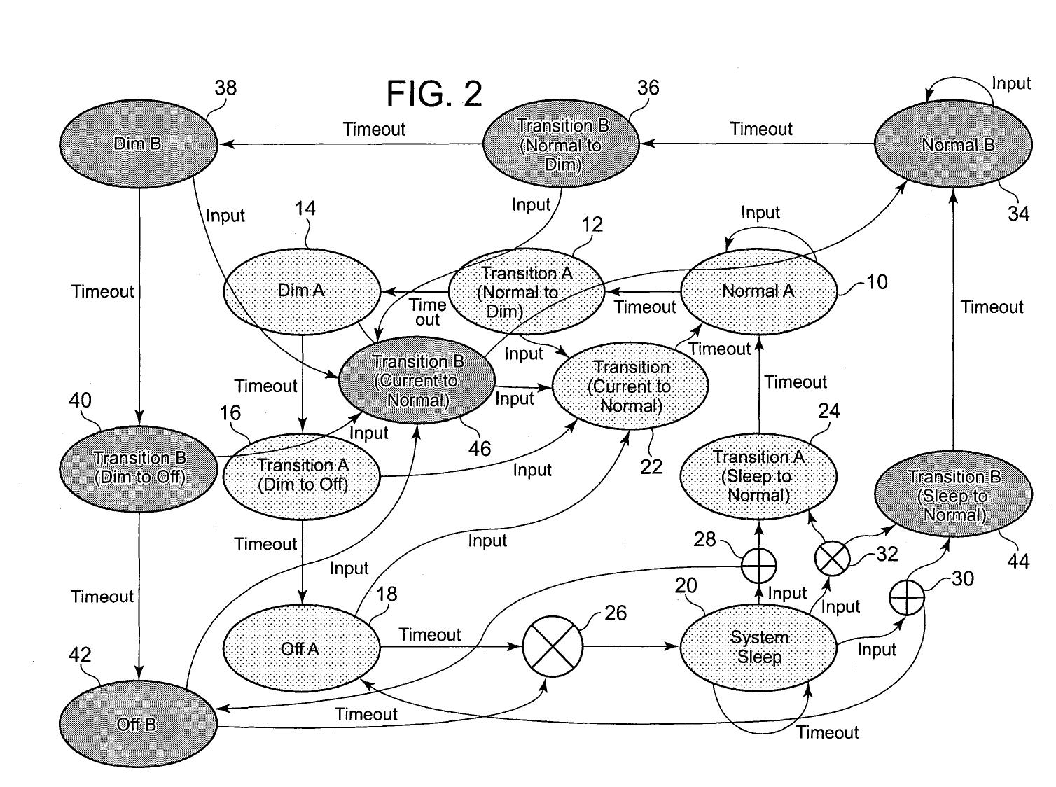

Turning now to FIG. 2, there is provided a state machine diagram relating to a dual-screen electronic device, such as laptop computing device, exhibiting independent power management in accordance with an embodiment of the invention for the display of different images on each of the two screens.

As will be appreciated, the respective set of states, and related transitions, is provided for the power management scenario for each respective screen although there are of course some necessary junctions formed between the respective states/transitions.

For ease of reference, the numerical notation employed in relation to the states/transitions of a first screen A mirrors that employed in FIG. 1. Thus, there is again provided a normal state 10 allowing for a self-loop “input” transition, and which itself transitions via “Transition A (Normal to Dim)” state 12, in which the backlight power transitions from the Normal level to the Dim level, to a “DimA” state 14; with onward potential transitioning to “Transition A (Dim to Off)” state 16, in which the backlight power transitions from a Dim level to an Off level, to an “Off A” state 18. Transitioning via a transition state 22 back to the normal state again arises should new user input be detected and the screen backlight transitions from the current brightness to the Normal level. In any of the steady states 10, 14, the API allows the application to suppress transitions to states 12 and 16 respectively, through overriding the timeout.

However, with regard to a “System Sleep” state 20, such as state interfaces also with the power management functionality according to a second screen B of the two screens and there are various transition condition junctions 26-32 provided and as illustrated and discussed further,

Turning now to the set of states and transition conditions relating to the second screen B, these likewise mirror those of screen A.

Thus, a “Normal B” state 34 exists with an appropriate self-loop “input” transition as the user input to the device is detected and reflected by the output of screen A. A “Transition B (Normal to Dim)” state 36 then arises should a timeout occur and the screen backlight would transition from the Normal to the Dim brightness. After a timeout the screen B can transition to the state “Dim B” 38. Likewise, after a further timeout the state machine can transition to the “Transition B (Dim to Oil)” state 40, in which the screen is transitioned from the Dim to the Off brightness, and then s after a further timeout indicating that transition to an “Off B” state 42 would be appropriate for the second of screen B. In any of the steady states 34, 38, the API allows the application to suppress transitions to states 36 and 40 respectively, through overriding the timeout.

Again, if at any time during the transition states 36, 40, or while at the steady states 38, 42, it is determined that user input requires transitioning via the state “Transition B (Current to Normal)” 46 back to the “Normal state 34, in such transitioning is provided as indicated.

Although the power management for each of the screens A, B of the device is therefore autonomous, the state machine necessarily includes some junction so as to allow for common control and power management features that will be required for all “system sleep” functionality for the whole multi-screen device.

Thus, and as illustrated, the entry to the “system sleep” state 20 will only be achieved with an appropriate transition via junction 26 if it is determined that the respective timeouts associated with the state “Off A” 18 and the state “Off B” 42 have been exceeded.

Further, the junctions 28, 30 allow for transitioning so as to allow the device to exit its “System Sleep” 20 mode either as part of a transition state 24, 44 back to a normal operative state 10, 34 after a timeout; or as part of a return of one of the screens B, A respectively to their off states 42, 18.

As an additional possible transition condition, the detection of user input can also serve, via junction 32, to initiate simultaneous transition states 24, 44 of both screens A, B back to their normal operative states 10, 34 after a timeout

Thus, as will be appreciated from reference to FIG. 2, the operative steady states of the screens, i.e. “normal”, “dim” and “off” can be initiated in a manner quite independently of each other. Of course, it should be appreciated that the three states illustrated are merely non-limiting examples and that any appropriate state of display screen operation can be offered/achieved by way of the independent control of the present invention.

Thus, the preservation can readily provide for multiple screens within a device each having independent control power management. Yet further, the control of the power engagement of such multiple screens can be achieved by way of the actual applications themselves as running on the device and, in this manner, the application can then be arranged to access the power management system of the device.

As one example, this can be achieved by way of a suitable API which is then arranged to be exposed to the particular applications.

Of course, in so far as different applications will have different display requirements, such as example different time periods, different levels of screen brightness, contrast etc, the invention can be arranged with user interface functionality allowing for the separate adjustment and control of such parameters as relevant to each of the possible applications. Of course, in further detail, such user control could be implemented by way of a menu-driven system forming part of the user interface of the application or alternatively, by way of a menu of the user interface at system level.

In so far as an API represents the most likely means for allowing an application to access the power management system, a basic design of such interface will serve to allow for transitions to be suppressed, timeouts to be programmed, management of power requirements of the screens and of course for the individual programming of parameters for each screen.

As a mere example the following enumerations are provided merely as an illustration of a possible working embodiment of appropriate APIs.

```
    Enumerations
enum  enum_onoff { PM_OFF = 0, PM_PROHIBIT = PM_OFF, PM_ON, PM_GRANT =
PM_ON } /* allows the suppression of screen transitions depending on the application purpose
*/
enum  enum_state { PM_STATE_NORMAL, PM_STATE_TRANSITION_NORM_TO_DIM,
PM_STATE_DIM, PM_STATE_TRANSITION_DIM_TO_OFF PM_STATE_OFF,
PM_STATE_SLEEP /* allows the brightness and position in the state machine to be controlled
by the application */
enumcontrol_scheme (PM_MANAGE_SCREENS_TOGETHER,
PM_MANAGE_SCREENS_INDIVIDUALLY)
    Functions
intpm_overall_control (enumcontrol_scheme scheme) /* set policy on how to manage screens */
int pm_control_screen_A (enumenum_state state, enumenum_onoffonoff) /* control of screen A
*/
int pm_control_Screen_B (enumenum_state state, enumenum_onoffonoff) /* control of screen
B */
```

As required, applications running on the device can then access such APIs to establish the appropriate usage policy of the power management functionality and so achieve individual control for each of the multiple screens. The applications will of course most appropriately be created within a Software Development Kit (SDK) which would have such APIs exposed.

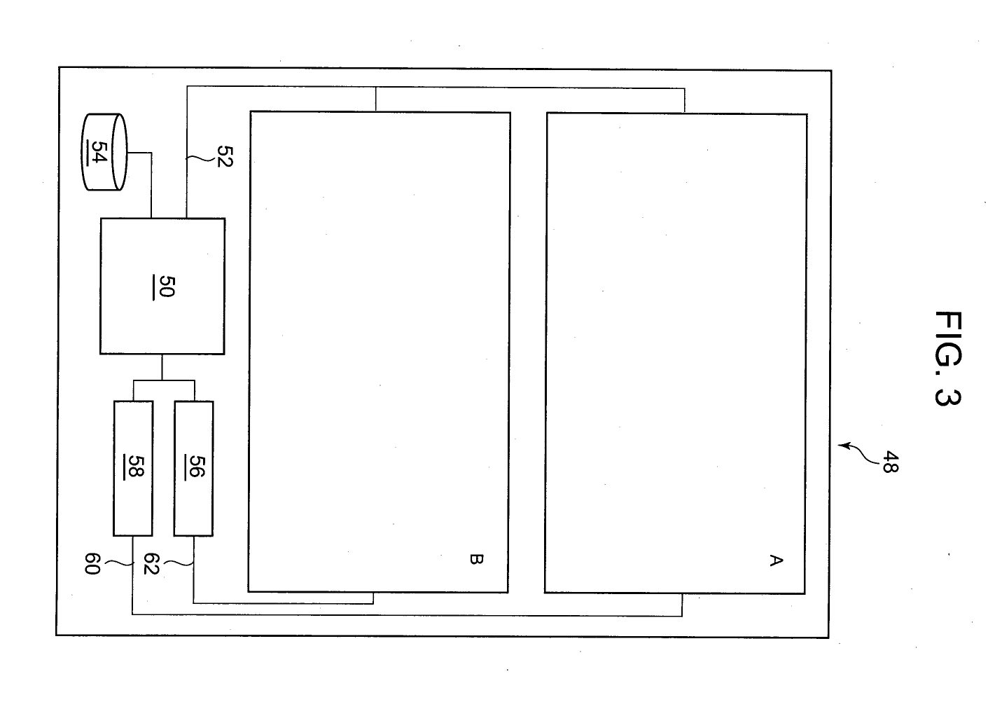

Referring now to FIG. 3 there is provided, in schematic block form, an illustration of a portable computing device 48 according to an embodiment of the present invention.

The device 48 comprises a dual-screen device having two screens A, B which, if required, can exhibit touch functionality.

A processor 50 is provided for operation of the device and, in particular, for the display, by way of bus 52, of appropriate images on each of the screens A, B. It should be appreciated that, although the screens A, B may differ in size they nevertheless have the ability to display images to the same degree of quality.

As is of course standard, storage functionality 54 is provided within the device 48 associated with the processor 50. As noted, either or both of the screens A, B can include touch sensitivity to serve as a user interface device. In this manner, a user can interface with the device 48 so as to set the appropriate parameters for the control of various characteristics of either or both, of the screens A, B quite independently of each other, and independently of the particular application that may be running on the device 48. For ease of reference, each of the two screens is illustrated with a respective power management system 56, 58 which serves to control display characteristics of either screen A, B separately by way of control lines 60, 62 that are relevant to power requirements, and in an independent manner. Thus, the timeout between screen power transitions can be set to be quite different for the two screens A, B and indeed as between different applications; likewise for matters of screen brightness, backlight intensity and contrast and any other characteristic as required/appropriate.

By way of further illustration, references now made to potential operational examples.

As a first example, a messaging application can be considered to be running over both screens A, B of the device of 48 and with the message composer displayed on screen A, and a QWERTY touch input keypad displayed on screen B. Screen A should of course remain brighter so as to emphasise the message being composed. However, screen B can transition to a is “dimmed” state since all it is required to display is a monochrome image of a keypad and high intensity is unnecessary from a user's perspective. The power requirement for screen B can therefore be reduced so as to enhance energy consumption efficiency and without having any effect whatsoever on user experience.

As a second example, the device can be arranged to run a media player application which will employ bath screens. In this example, the media in-focus is displayed on screen A and a media thumbnail carousel and control (for example offering play, stop, FF, RWD, etc functionality) can be displayed on screen B. For applications involving a video replay for example, screen A would remain in an “always on” state while the media is active; whereas screen B can be arranged to transition to a “dimmed”, or even an “OFF” state once (re)play is started. it will then only be re-illuminated upon experiencing a touch-event from the user. Thus, screen B remains very much active and under the control of the power management functionality but with an output control to be appropriate to the circumstances and characteristics of the application being run. Such careful control advantageously serves to reduce power consumption without any decreased performance for the user.

Of course, it should be appreciated that this invention is not restricted to the details of the foregoing embodiments.

For example, the device can employ any appropriate number of screens and be arranged to run any appropriate application requiring the display of, generally different, images on the two screens. The power management control of each screen can then proceed in the most efficient manner dependent upon the use that the application requires of each respective screen and of course quite independently of each other. The types of control and display characteristics are mere examples and so should be considered non-limiting.

This application is based upon and claims the benefit of priority from United Kingdom patent application No. 1119709.2. filed on Nov. 15, 2011, the disclosure of which is incorporated herein in its entirety by reference.

1. An electronic device having a first surface area offering a first display and a second surface area offering a second display, the device being arranged to display different images on the first and second displays and having independent power management functionality for the first and second displays and operative while the displays are displaying the said different images.

2. A device as claimed in claim 1 and arranged such that applications running on the device can control the power management functionality.

3. A device as claimed in claim 2, wherein the applications are arranged to access a power management system of the device.

4. A device as claimed in claim 1, and arranged to control the power management functionality for control of power-dependent display characteristics of each of the displayed images.

5. A device as claimed in claim 1, wherein access for the said applications to the power management functionality is achieved by way of an Application Program Interface.

6. A device as claimed in claim 5, and with the applications having been created within a Software Development Kit having the relevant Application Program Interfaces exposed.

7. A device as claimed in claim 1 and including user interface means allowing for the programming of threshold levels of power dependent display characteristics within the power management functionality.

8. A device as claimed in claim 7 and arranged to allow for variation of the said threshold levels in an application-dependent manner.

9. A method of power management for an electronic device having a first surface area offering a first display and a second surface area offering a second display, the device being arranged to display different images on the first and second displays, and the method including the step of providing power management to the first and second displays independently of each other and while both the first and second displays are displaying the

10. A method as claimed in claim 9, including the step of controlling the power management by means of an application running on the device.

11. A method as claimed in claim 9, and wherein the applications access a power management system of the device.

12. A method as claimed in claim 9 and wherein the step of controlling the power management functionality is taken responsive to power-dependent display characteristics of each of the displayed images.

13. A method as claimed in claim 9, wherein the step of accessing the power management functionality is taken by way of an Application Program Interface.

14. A method as claimed in claim 9 and including exposure of the Application Program Interface by way of a Software Development Kit within which the applications have been created.

15. A computer program having instructions which, when executed, provide for a method as defined in claim 9.

16. A computer program product comprising a computer program element as defined in claim 15.

17. A computer-readable medium having a computer program product as claimed in claim 16 recorded thereon.
